(19) United States
(12) Patent Application Publication
(10) Pub. No.: US 2007/0055879 A1
(43) Pub. Date: Mar. 8, 2007

(54) System and method for high performance public key encryption

(76) Inventors: Jianjun Luo, Cupertino, CA (US); David K. Chin, Los Altos, CA (US); Terry K. Tham, Cupertino, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/205,851

(22) Filed: Aug. 16, 2005

(51) Int. Cl. H04L 9/00

(52) U.S. Cl. 713/171

(57) ABSTRACT

A method and apparatus for high performance public key operations which allows key sizes longer than 4K bit, without substantial degradation in performance. The present invention provides variations of modular reduction methods based on standard Barrett algorithm (modified Barrett algorithm) to accommodate RSA, DSA and other public key operation. The invention includes a unique microcode architecture for supporting highly pipelined long integer (usually several thousand bits) operations without condition checking and branching overhead and an optimized data-independent pipelined scheduling for major public key operations like, RSA, DSA, DH, and the like.

### TECHNICAL FIELD

This application relates to data encryption systems and, more specifically, to a hardware-based public key operation.

### BACKGROUND

A variety of cryptographic techniques are known for securing transactions in data communication. For example, the SSL protocol provides a mechanism for securely sending data between a server and a client. Briefly, the SSL provides a protocol for authenticating the identity of the server and the client and for generating an asymmetric (private-public) key pair. The authentication process provides the client and the server with some level of assurance that they are communicating with the entity with which they intended to communicate. The key generation process securely provides the client and the server with unique cryptographic keys that enable each of them, but not others, to encrypt or decrypt data they send to each other via the network.

Public key cryptography is a form of cryptography which allows users to communicate securely without a previously agreed shared secret key. Public key cryptography provides secure communication over an insecure channel, without having to agree upon a key in advance.

Public key encryption algorithms, such as Rivest Shamir and Adleman (RSA), DSA, Diffie-Hellman (DH), and others, typically use a pair of two related keys. One key is private and must be kept secret, while the other is made public and can be publicly distributed. Public-key cryptography is also referred to as asymmetric-key cryptography because not all parties hold the same information.

Public key cryptography has two main applications. First, is encryption, that is, keeping the contents of messages secret. Second, digital signatures (DS) can be implemented using public key techniques. Typically, public key techniques are much more computationally intensive than symmetric algorithms.

FIG. 1 illustrates a typical personal computer-based application of public keys. As shown, a client device stores its private key (Ka-priv) 114 in a system memory 106 of a computer 100. To reduce the complexity of FIG. 1, the entire computer 100 is not shown. When a session is initiated, the server encrypts the session key (Ks) 128 using the client's public key (Ka-pub) then, sends the encrypted session key (Ks) Ka-pub 122 to the client. As represented by lines 116 and 124, the client then retrieves its private key (Ka-priv) 114 and the encrypted session key 122 from the system memory 106 via the PCI bus 108 and loads them into a public key accelerator 110 in an accelerator module or card 102. The public key accelerator 110 uses this downloaded private key (Ka) 120 to decrypt the encrypted session key 122. As represented by line 126, the public key accelerator 110 then loads the clear text session key (Ks) 128 into the system memory 106.

When the server needs to send sensitive data to the client during the session the server encrypts the data using the session key (Ks) and loads the encrypted data [data] Ks 104 into system memory. When a client application needs to access the plaintext (unencrypted) data, it may load the session key 128 and the encrypted data 104 into a symmetric algorithm engine (e.g., 3DES, AES, etc.) 112 as represented by lines 130 and 134, respectively. The symmetric algorithm engine 112 uses the loaded session key 132 to decrypt the encrypted data and, as represented by line 136, loads plaintext data 138 into the system memory 106. At this point, the client application may use the data 138. The client's private key (Ka-priv) 114 may be stored in the clear (e.g., unencrypted) in the system memory 106 and it may be transmitted in the clear across the PCI bus 108.

Hardware components such as an encryption engine may perform asymmetric key algorithms (e.g., DSA, RSA, Diffie-Hellman, etc.), key exchange protocols, symmetric key algorithms (e.g., 3DES, AES, etc.), or authentication algorithms (e.g., HMAC-SHA1, etc.). However, the performance of hardware-based public key encryption engines (PKE) are determined by efficient implementation of modular arithmetic, specially modular reduction required in public key encryption. A public key operation requires intensive modular arithmetic, which in turn, requires modular reduction. One technique used for modular reduction is Barrett algorithm, described in P. Barrett, Implementing the Rivest Shamir and Adleman Public Key Encryption Algorithm on a Standard Signal Processor, Advances in Cryptology- CRYPTO '86 Proceedings, Springer-Verlag, 1987, pp. 311-323, the content of which is hereby expressly incorporated by reference. Though, Barrett algorithm is typically best for small arguments.

However, to achieve a more robust security, long size keys are desirable. Long size keys require long integer modular arithmetic that is not best suited for a regular Barrett algorithm. Therefore, there is a need for a high performance hardware-based system and method for public key operations which allows large key sizes.

### SUMMARY OF THE INVENTION

In one embodiment, the invention is a method for accelerating public key operations. The method includes the steps of: receiving an input including type of encryption, the public key or private key parameters, and data payload; decoding the received input to determine the type of encryption, the size of the key parameters, and the data payload; storing the key parameters and the data payload in pre-assigned locations of a memory depending on the determined type of encryption; generating microcode on the fly responsive to the determined type of encryption and the stored key parameters and the data payload; executing the generated microcode in a single-cycle based pipeline structure; and outputting the public key operation results.

In one embodiment, the invention is a system for accelerating a public key operation. The system includes an input buffer for receiving an input including type of encryption, public key or private key parameters, and data payload; a parser for decoding the received input to determine the type of encryption, the size of the key parameters, and the data payload; a memory for storing the key parameters and the data payload in pre-assigned locations depending on the determined type of encryption; a microcode generation module for generating microcode on the fly responsive to the determined type of encryption and the stored key parameters and the data payload; an execution unit for executing the generated microcode in a single-cycle based pipeline structure; and an output buffer for outputting the public key operation results.

### BRIEF DESCRIPTION OF THE DRAWINGS

FIG. 1 illustrates a typical personal computer-based application of public keys;

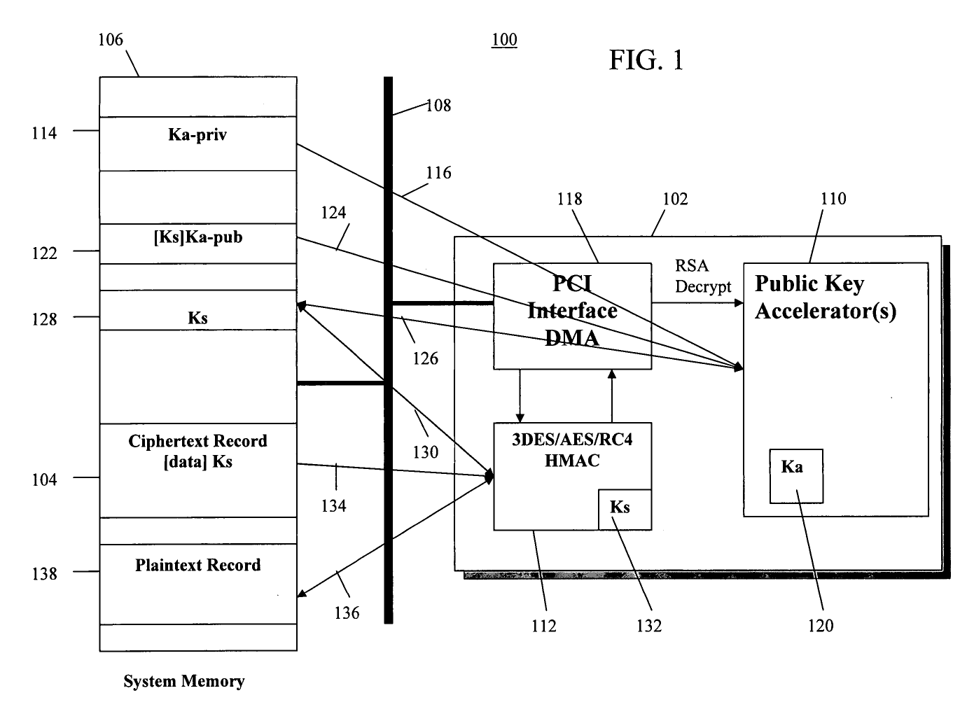

FIG. 2 is an exemplary block diagram of a PKE, according to one embodiment of the present invention;

FIG. 3 is an exemplary block diagram of a PKE core, according to one embodiment of the present invention;

FIG. 4 is an exemplary microcode instruction format, according to one embodiment of the present invention;

FIG. 5 is an exemplary block diagram depicting the memory structure, according to one embodiment of the present invention;

FIG. 6 is an exemplary process flow for a modular operation, according to one embodiment of the present invention; and

FIG. 7 shows different pipeline stages in an exemplary PKE core, according to one embodiment of the present invention.

### DETAILED DESCRIPTION

In one embodiment, the present invention is a method and apparatus for high performance public key operations which allows key sizes longer than 4K bit, without substantial degradation in performance. The present invention provides variations of modular reduction methods based on standard Barrett algorithm (modified Barrett algorithm) to accommodate RSA, DSA and other public key operation. The invention includes a unique microcode architecture for supporting highly pipelined long integer (usually several thousand bits) operations without condition checking and branching overhead and an optimized data-independent pipelined scheduling for major public key operations like, RSA, DSA, DH, and the like. The microcode is generated on the fly, that is, the microcode is not preprogrammed but instead, is generated inside the hardware after public key operation type, size and operands are given as input. Once a microcode instruction is generated, it's decoded and executed immediately in a pipelined fashion. No memory storage is needed for the generated microcode. Furthermore, the generated microcode does not contain any condition checking or jumps. This way, the microcode is optimized to perform long integer modular arithmetic operations in a single-cycle based pipeline architecture.

In one embodiment, the invention includes a high-performance Multiplier/Adder (MAC) core to support specially designed microcode instructions, a unique memory structure and address mapping to support up to three Read and one Write operations simultaneously using standard dual port memories (e.g., a dual port RAM), and an auto microcode generating module that generates microcode for different size of operands on the fly.

The invention utilizes optimized hardware modular arithmetic algorithms for public key operations, high-performance hardware reciprocal algorithms for different precision requirements, and an optimized Extended Euclid algorithm for computing modular inverse or long integer divisions required in the public key operations.

Three modified Barrett algorithms have been devised that are capable of handling long integer modular arithmetic. All long integer modular arithmetic except modular addition and modular subtraction use the modified Barrett algorithms. All these supported modular arithmetic including modular reduction, modular addition, modular subtraction, modular inverse, modular multiplication, modular squaring, modular exponentiation, double modular exponentiation for DH, RSA, and DSA are summarized below.

1. Modular Reduction

Modified Barrett's Method 0: (for most public key operations)
Input: x=(x₂ₖx₂ₖ₋₁ . . . x₁x₀)_{b}, m=(mₖ₋₁ . . . m₁m₀)_{b}, b=2²⁵⁶, mₖ₋₁≠0, 0≦x₂ₖ<2⁴.
Output: r=x mod m
u=└b^{2k+1}/m┘, q₁=└x/b^{k-1}┘, q₂=q₁*u, q₃=└q₂/b^{k+2}┘.
r₁=x mod b^{k+1}, r₂=q₃*m mod b^{k+1}, r=r₁−r₂.
If r<0, r=r+b^{k+1}.

While r>=m do: r=r−m. /* loop is repeated at most twice */
Return(r).

Modified Barrett's Method 1: (for DSA public key operations only)
Input: x=(x₄ₖ₋₁ . . . x₁x₀)_{b}, m=(mₖ₋₁ . . . m₁m₀)_{b}, b=2²⁵⁶, mₖ₋₁≠0.
Output: r=x mod m
u=└b^{4k}/m┘, q₁=└x/b^{k-1}┘, q₂=q₁*u, q₃=└q₂/b^{3k+1}┘.
r₁=x mod b^{k+1}, r₂=q₃*m mod b^{k+1}, r=r₁−r₂.
If r<0, r=r+b^{k+1}.
While r>=m do: r=r−m. /* loop is repeated at most twice */
Return(r).

Modified Barrett's Method 2: (for RSA public key operations only)
T1=G^{U1} mod P; T2=Y^{U2} mod P;/* dbl exponentiation */ /* using pre-calculated UP */
Z=T1*T2 mod P /* using pre-calculated UP */
V=Z mod Q /* using pre-calculated UQ */
Return(V).

In one embodiment, the present invention utilizes a modified Barrett algorithm to perform modular reduction. The system of the present invention therefore needs to calculate u=└b^{2k+1}/N┘ so that it can perform A mod N, where N is up to 4096-bit modulus, A is at most twice the size of N plus 4 bits, and b=2²⁵⁶. Because of A and N size ratio limitation, we devise another two modified Barrett algorithm to support different A and N size ratios required in some DSA and RSA operations.

Actually, in some DSA operations, different p, q size RSA Chinese Remainder Theory (CRT) operations and division (needed by Extended Greatest Common Divisor (GCD)), different precision u is needed. In one embodiment, the invention supports 4 different precision u calculations. Precision 0 is for u=└b^{2k+1}/N┘, Precision 1 is for u=└b^{4k}/N┘, Precision 2 is for u=└b^{3k}/N┘, and Precision 3 is u=└b^{k+2}/N┘ (only for this precision, the condition Nₖ₋₁≠0 is not needed).

All long integers will be divided into multiples of 256 bits to participate in arithmetic operations because 256-bit is the operand size of our current arithmetic core unit.

Following definitions will be used throughout this document:
b—high radix (data width), b=2²⁵⁶
N—modulus before normalization N=(Nₖ₋₁Nₖ₋₂ . . . N₀)_{b}, Nₖ₋₁≠0
d—modulus after normalization
n—length of modulus N in bits (16≦n≦4096)
k—number of bits in radix b for N=(Nₖ₋₁Nₖ₋₂ . . . N₀)_{b} where Nₖ₋₁≠0,
k=┌n/256┐
K—length of modulus N in bits that ceiled to next 256-bit boundary, K=k*256

Exception: K=512 when k=1.
p—precision (in bits) required for i+1ₜₕ Newton iteration.
s - - - normalized shifting count

In one embodiment, the present invention modifies the Newton Raphson reciprocal iteration algorithm for a better performance. The Newton Raphson reciprocal algorithm is modified to include truncations and use 1's complements (instead of 2's complements), as illustrated below.

The basic Newton Raphson method is performed using the following equation:

| | |
|---|---|
| R[i+1] = R[i](2 − dR[i]) | /* R[0] = initial approximation of 1/d |
| ε[i+1] = ε[i]² | /* ε[i] = (1/d − 1/R[i]) / (1/d) = 1 − |
| dR[i] | |

However, the above basic Newton Raphson method is modified for a more efficient hardware implementation.

| | |
|---|---|
| Y[i] = dR[i] | /* R[0] = initial approximation of 1/d, |
| 1≦d<2 */ | |
| Z[i] = 2 − Y[i] − ulp | /* use 1's complement |
| instead of 2's */ | |
| | /* ulp = 2^{-(K+m)} where */ |

```
  /* m is len of R[i] in bits excluding 1 integral bit */
  /* K is len of d in bits excluding 1 integral bit */
R[i+1] = R[i]Z[i] − 2^{-p}R_{f}[i+1] /* truncate R[i]Z[i] to p+1 bit
b₀.b₁b₂b_{3...}bₚ */
        /* p is precision we need for i+1ₜₕ iteration */
            /* 0≦R_{f}[i+1]<1 */
  ε[i+1] = ε[i]² + ulp(1 − ε[i]) + 2^{-p}dR_{f}[i+1]
    < 2ε[i]² /* we make sure ulp(1 − ε[i]) + 2^{-p}dR_{f}[i+1] <
ε[i]² */
```

As shown above, the modified Newton Raphson method performs possible truncation on dR[i], uses 1's complement instead of 2's complement in 2-Y[i], and truncates R[i]Z[i] (thus R[i] size varies per iteration. More aggressive truncations can be done in early iterations.

The following Table 1 shows precision errors based on different number of iterations. Depending on operation type and size of the key, different error tolerance (precision) may be chosen from the table, which in turn, gives the number of required iterations.

TABLE 1
Relative Error Table under Modified Newton Raphson method:

| | |
|---|---|
| ε[0] < 2⁻⁹ , | /* initial approximation */ |
| ε[1] < 2⁻¹⁷ , | |
| ε[2] < 2⁻³³ , | |
| ε[3] < 2⁻⁶⁵ , | |
| ε[4] < 2⁻¹²⁹ , | |
| ε[5] < 2⁻²⁵⁷ , | |
| ε[6] < 2⁻⁵¹³ , | |
| ε[7] < 2⁻¹⁰²⁵ , | |
| ε[8] < 2⁻²⁰⁴⁹ , | |
| ε[9] < 2⁻⁴⁰⁹⁷ , | |
| ε[10] < 2⁻⁸¹⁹³ , | |

In one embodiment, a special purpose hardware performs the modified Newton Raphson method as follow:

Input:

Integer k, precision type Precision, n-bit integer N=(Nₖ₋₁ Nₖ₋₂ . . . N₀)_{b} where 16≦n≦4096 or higher, b=2²⁵⁶, Nₖ₋₁≠0 (except Precision=3). Leading bits of N could be 0 before normalization.

Output:

If Precision=0, return (k+2)*256-bit reciprocal R=└b^{2k+1}/N┘=└2^{(2k+1)*256}/N┘;

If Precision=1, return (3k+1)*256-bit reciprocal R=└b^{4k}/N┘=└2^{4k*256}/N┘;

If Precision=2, return (2k+1)*256-bit reciprocal R=└b^{3k}/N┘=└2^{3k*256}/N┘;

If Precision=3, return (s1+3)*256-bit reciprocal R=└b^{k+2}/N┘=└2^{(k+2)*256}/N┘.

Method:

i) Normalize N into d so that N=d*2^{-s}*2^{K}, 1≦d<2 (d=1.b₁b₂b₃ . . . b_{K}), s=k*256—n+1, calc s1=(s−1)/256. If k=1, pad zeros at the end of d to make sure d has at least 512-bit fraction (K≧512).
ii) Use Midpoint Reciprocal Table (9-bits-in, 8-bits-out) or Bipartite Reciprocal Table to obtain initial approximation of 1/d R[0] with 9 bit precision, that's, ε [0]<2⁻⁹.

iii) Determine the number of iterations T.

/* The number of iterations T is determined by Relative Error Table */
/* and the required precision p_{final} of reciprocal └2^{(2k+1)*256}/N┘(in bits)
/* P_{final} = (2k+1)*256 − n +1 include the significant bits in reciprocal

| | |
|---|---|
| /* it can be proven that └2^{(2k+1)*256}/N┘ <2^{(k+2)*256} | */ |

| | |
|---|---|
| /* Thus, p_{final}=(k+2)*256= K+512 is chosen. | */ |
| if (k>1) | |

K=256*k;

else

K=512;
Switch (Precison)
{

| | | |
|---|---|---|
| case 0: | p_{final}= (k+2)*256; | kk = k; break; |

| | |
|---|---|
| case 1: | p_{final}= (3*k+1)*256; kk = 3*k − 1; break; |
| case 2: | p_{final}= (2*k+1)*256; kk = 2*k − 1; break; |
| case 3: | p_{final}= (s1+3)*256; kk = si +1; break; |

}
Switch (kk)
{

| | |
|---|---|
| case 1, 2: | /* 16-512 bit modulus, p_{final}=768 or 1024 */ |

| | | |
|---|---|---|
| T = 7; | break; | /* ε[7] < 2⁻¹⁰²⁵ */ |

| | |
|---|---|
| case 3 . . . 6: | /* 513-1536 bit modulus |

p_{final}=1280,1536,l792,2048 */

| | | |
|---|---|---|
| T = 8; | break; | /* ε[8] < 2⁻²⁰⁴⁹ */ |

| | |
|---|---|
| case 7 . . . 14: | /* 1537-3584 bit modulus, |

| | |
|---|---|
| p_{final}2304,2560,28l6, | */ |

/* 3072, 3328,3584,3840,4096

*/

| | | |
|---|---|---|
| T = 9; | break; | /* ε[9] < 2⁻⁴⁰⁹⁷ */ |

| | |
|---|---|
| case 15, 16: | /* 3585-4096 bit modulus, |

p_{final} = 4352,4608 */

| | | |
|---|---|---|
| T = 10; | break; | /* ε[10] < 2⁻⁸¹⁹³ */ |

default: /* set default to k=1 */

| | |
|---|---|
| T = 7; | break; |

}

| | |
|---|---|
| iv) | Refine reciprocal approximation by Newton iterations. |

for (i=0; i<5; i++) /* keep R[0-4] as 256+1 bit, R[5] as
512+1 bit */

| { | /* d=1.b₁b₂b_{3...}b_{K}, R[0-4]=r₀.r₁r₂r_{3...}r₂₅₆, R[5]=r₀.r₁r₂r_{3...}r₅₁₂ */ | |
|---|---|---|
| | if (i=4) p=512 else p=256 | |
| | Y[i] = dR[i] − 2^{-K}Y_{f}[i]; | /* truncate to K+1 bits, |

0≦Y_{f}[i]<1 */

| | |
|---|---|
| Z[i] = 2 − Y[i] − 2^{-K}; | /* ulp = 2^{-K} */ |
| R[i+1]= R[i]Z[i] − 2^{-p}R_{f}[i+1]; | /* 0≦R_{f}[i+1]<1 */ |
| ε[i+1] = ε[i]² + 2^{-K}(1 − ε[i]) (1 - Y_{f}[i]) + 2^{-p}dR_{f}[i+1] ; | |
| /* ε[i+1] <ε[i]² + ε[i]²=2ε[i]² because K≧512 and p=256 or 512 | |

*/
}
/* we obtain at least 256 bit precision or ε[5] < 2⁻²⁵⁷ after
5^{th} iteration */
for (i=5; i<T; i++) /* keep R[i] as m+1 bit */

| | |
|---|---|
| { | /* d=1.b₁b₂b_{3...}b_{K}, R[i]=r₀.r₁r₂r_{3...}rₘ */ |

m=256 + 256*2ⁱ⁻⁵;

| | p=m+256*2ⁱ⁻⁵; | | |
|---|---|---|---|
| Y[i] = dR[i]; | | /* drop MSB integral bit */ | |
| | Z[i] = 2 − Y[i] − 2^{-(K+m)}; | | /* ulp = 2^{-(K+m-1)} */ |
| | R[i+1]= R[i]Z[i] − 2^{-p}R_{f}[i+1]; | | /* truncate to p+1 |

bit*/

ε[i+1] = ε[i]² + 2^{-(K+m)}(1 − ε[i]) + 2^{-p}dR_{f}[i+1] ;
/* ε[i+1] <2ε[i]² (i<T−1) or ε[i+1] < 2^{-pfinal} (i=T−1) */
/* because 2^{-(K+m)}(1 − ε[i]) + 2^{-p}dR_{f}[i+1] <ε[i]² for all i<T−1

*/
}

| | |
|---|---|
| if (i==T) | /* when i=T−1, p > p_{final} before adjustment */ |
| | /* truncate more to p_{final} bits */ |

R[T] = R[T] * 2^{p} >> (p − p_{final})

v) Denormalize R[T] so that R = └2^{(2k+1)*256}/N┘= r₁r₂r₃...r_{K+512}
=(R[T]<<s)>>256.

| | |
|---|---|
| vi) | Output (k+2)*256 bit reciprocal R |

In short, a typical modular operation according to a modified Barrett algorithm can be summarized as follow (exponentiation R=A^{E} is used as an example here):
Step 0: Calculate reciprocal u=└b^{2k+1}/N┘ using the devised modified Newton Raphson method
Step 1: multiplication or addition (In this example, X=R*R or X=A*R depending on current exponent bit is 1 or 0, initial R=A)
Step 2=partial Barrett reduction per our modified Barrett algorithm
   q1=└X/b^{k-1}┘
   q2=q₁*u
   q3=└q₂/b^{k+2}┘
   r1=X mod b^{k+1}
   r2=q₃*N mod b^{k+1}
   R=r1−r2
Step 3: loop step 1 and 2, if loop not done; Otherwise, go to step 4
Step 4=Final Correction: while R>=N, do: R=R−N (modular operation)

A reciprocal algorithm according to modified Newton Raphson method is summarized as follow:
Step 0: input operand to be calculated (modulus N);
Step 1: Normalize N to get d;
Step 2: Use Lookup table to get rcpl seed R0 (repl-tbl)
Step 3: Determine iteration number (ctl-rcpl) using Relative Error Table and size of N, precision type (0-3)
Step 4: reciprocal main portions in each iteration
   Y=d*R
   Z=1's complement of Y
   R=Z*R
Step 5: Denormalize R (left shift R by S bit)
Step 6: output reciprocal R of N
   R=└b^{m}/N┘, m=2k+1, 3k+1, . . .

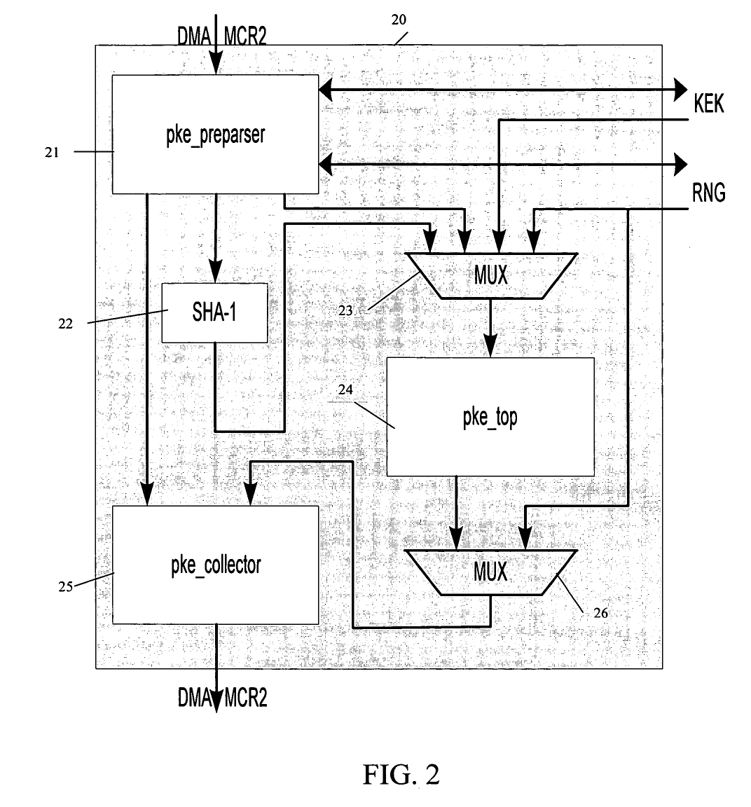

FIG. 2 is an exemplary block diagram of a PKE, according to one embodiment of the present invention. As shown, a preparser block 21 receives MCR2 packet from DMA and parses the packet to determine type of encryption operation, size of the key, data payload and the like. The general information of input packet like packet header, operation type, size, etc., as output of the preparser 21 is fed to a pke_collector 25 to control the result collection in the last stage. The output of the preparser 21 is also fed to a SHA-1 engine 22 to perform the hashing operation on unhashed messages required in DSA operation. The output of the preparser 21 is also fed to a multiplexor 23. The multiplexor 23 inputs also include plain keys from key encryption key (KEK) engine, a random number generated by a random number generator (RNG), and the output of the SHA-1 engine 22.

The multiplexor 23 selects one of its inputs based on operation type and its option parameters to feed to a PKE core 24. The PKE core performs the modular arithmetic based on modified Barrett algorithms. The output of the PKE core 24 and the random number are fed to a second multiplexor 26. The second multiplexor 26 select either the random number (if the operation type is RNG opcode) or the output of the PKE core 24 (if operation type is PKE opcode) and feeds it to the pke_collector 25. The pke_collector 25 packs the final result in a packet in a predefined format.

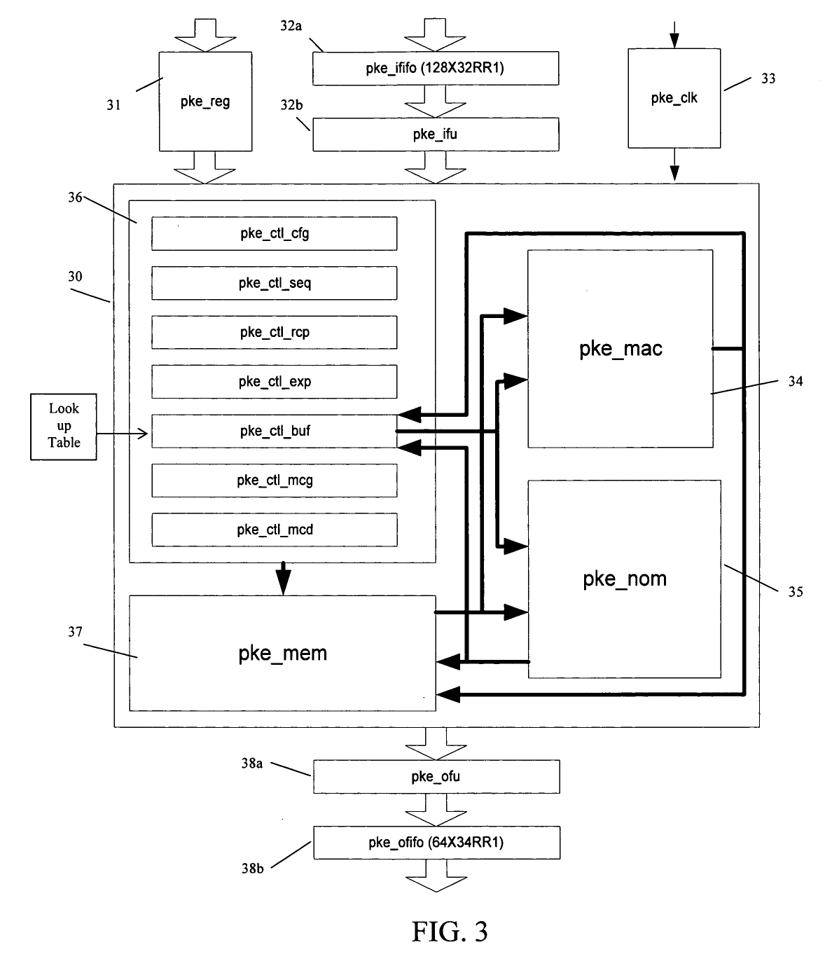

FIG. 3 is an exemplary block diagram of a PKE core, according to one embodiment of the present invention. As shown, the data payload is input to a FIFO 32a and then to a input parser 32b. A register block 31 provide some control registers used by PKE core. The clock to the PKE core 30 is generated by a clock gating circuit 33 for power saving purpose. A controller 36 includes several control blocks 36a to 36g. Configuration control block 36a stores parameters and status for current PKE operation. Reciprocal block (module) 36c generates some control information for reciprocal iterations like number of iteration, dropping count for each iteration,etc. Exponential block (module) 36d scans the exponent bits and provide information to control exponention iteration loop. A scratch pad buffer 36e is connected to a reciprocal seed look up table 39, the memory and output of arithmetic/shifting units. The data in scratch pad buffer 36e can be fed directly to arithmetic/shifting units without memory access laterncy. The scratch pad buffer 36e is also used to facilitate constant operands, copy operations.

Sequencer block 36b handles the top level operation sequencing. A microcode generation block (module) 36f generate micro code on the fly, as described in more detail below. A microcode decoder 36g decodes the generated microcode for the arithmetic operation of MAC 34 and shifting logic NOM 35. MAC 34 is a high performance pipelined multiplication and accumulation unit which supports operand sizes of 256 plus 4 bits. The Reciprocal block 36c, Exponential block 36d, scratch pad buffer 36e, MAC 34 and shifting logic 35 are collectively referred to as execution module.

A memory 37 stores the payload and data. In one embodiment, memory 37 is a dual port memory (e.g., a RAM) that includes a unique memory structure and address mapping to support up to three Read and one Write operations simultaneously. Output parser 38a and output FIFO 38b are used to output the result of the PKE core operations.

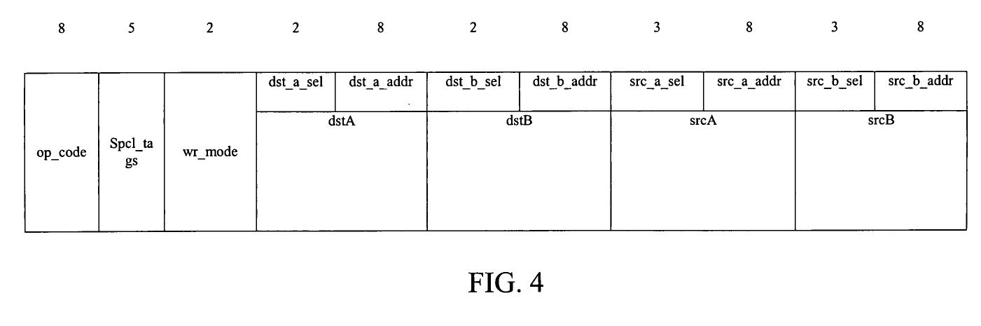

FIG. 4 is an exemplary microcode instruction format, according to one embodiment of the present invention. The number of bits assigned to each microcode field is for illustration purposes. Those skilled in the art would recognize that other bit lengths for different fields of the microcode are within the scope of the invention. The exemplary fields including some op_codes with different arithmetic operations on different operands are illustrated below. Particularly, NOM and DNOM op_codes are used for shifting operations performed in normalizer (PKE_NOM).

1. op_code (8 bits):

Pri-code (4bits):

| h0 | : NOP | |
|---|---|---|
| h1 | : COPY | (R→W) |
| h2 | : LOAD | (R→W) |
| h3 | : NOM | |
| | (R→L→S0→S1→S2→S3→S4→S5→S6→S7→W0→ | |
| | W1→S8/W) | |
| h4 | : DNOM | |
| | (R→L→S0→S1→S2→S3→S4→S5→S6→S7→W0→ | |
| | W1→S8/W) | |
| h5 | : ADD | two paths: (R→A0→A1→A2→W) or |
| | | (R→M0→M1→M2→M3→C→A0→A1→A2→W) |
| h6 | : SUB | two paths: (R→A0→A1→A2→W) or |
| | | (R→M0→M1→M2→M3→C→A0→A1→A2→W) |
| h7 | : MUL | (R→M0→M1→M2→M3→C→A0→A1→A2→W) |
| h8 | : MAC | (R→M0→M1→M2→M3→C→A0→A1→A2→W) |
| h9-F | : reserved | |

Where, R is a Read operation, W is a Write operation, S is a shift operation, L is a Load operation, Wₓ is a Wait operation, A is an Add operation, C is a carry-save 3-2 addition, and M is a Multiplication operation.

Sub-code (4 bits): subtypes for a specific primary operation (see below)

2. Spcl_tags (5 Bits): special tags needs for certain operations like conditional drop, etc.

| [0] | : | last instruction of current long integer |
|---|---|---|
| | operation microcode sequence. | |
| | | Used for setting status flags. |
| [1] | : | drop on previous MAC flags neg_flag set |
| [2] | : | drop on previous MAC flags neg_flag not set |
| [3] | : | drop on ctlbufo_sign not set (R0 >=0) |
| [4] | : | inverse all the result bits [256:0], [260:257] |

are cleared

| 3. | wr_mode (2 bits): only applies to destination write from |
|---|---|
| pke_mac/pke_nom | |
| | 00 : dst[260:0] [symbol] R[260:0] write all 261 bits |
| | (default) |
| | 01 : dst[260:0] [symbol] {5′b0, R[255:0]} |
| | 10 : dst[260:0] [symbol] {1′b0, R[3:0], dst[255:0]} |
| | 11 : dst[260:0] [symbol] {1′b0, R[259:0]} clear sign bit |
| | [260]. |

4. dst_sel (2 bits)/src_sel (3 bits) :
dst_sel :

| | |
|---|---|
| 00 | ram |
| 01 | buffer registers |
| 10 | reserved |
| 11 | no dst |

src_sel :

| | |
|---|---|
| 000 | ram |
| 001 | buffer registers |
| 010 | ALU feedback |
| 011 | immediate value (0 ˜ 255) |

100 no src
101-111 reserved

Note: for normalization instructions, srcB is always used to store dstA base address.

5. addr (8 bits):

Specify ram or control/buffer register address. Current RAM size is 4×64×261 bit. For control registers, currently we have 2 working parameter registers and 4 working buffer registers (R0, R1, R2 and R3).

Ram address format:

[7:6] ram_sel (RAM0˜RAM3)
[5:0] row_sel (ROW0˜ROW63)
Note: all columns (COL0˜COL7) are selected because of 256 bit
word size.

An exemplary microcode instruction set, according to one embodiment of the present invention, is described below.

| | |
|---|---|
| 1) NOP | No operation (1 cycle) |
| 2) COPY | R [symbol] A (2 cycles), optionally R0 [symbol] A |
| | A is in RAM, R can be in RAM or ctl_bufs. |

Optionally A can also be copied to ctlbuf0(R0) as long as A
is not R0. No memory write when using this instruction.

| | |
|---|---|
| 3) LOAD | R [symbol] ctl_buf0(R0)/immediate value (2 cycles) |
| | R is in RAM, immediate value is written through |

ctl_buf0(R0).

| | |
|---|---|
| 4) NOM | NOM1/NOM2/NOMF |
| NOM1 | clear normalizer internal states and counters; do |

leading one detection. It's used as first normalization
instruction.

| | |
|---|---|
| NOM2 | update normalizer states and counters; do |

normalization. It's used for second to last input data.

| | |
|---|---|
| NOMF | flush out the last result data in normalizer. |

It's always used as last normalization instruction.

| | |
|---|---|
| Note | Rules on result generation: |
| | 1) if status tag ld_one_found is false after a |

normalization, zero is written as result to dst_base + (ld_zero_cnt − 1).

2) if both status tags ld_one_found and

```
  first_nz_dat are true, no result is generated, Partial
  result resides in normalizer and need to be merged with
  next input data.
```

3) if ld_one_found is true but first_nz_dat is

false, one result is

written to dst_addr + ld_zero_cnt
4) always write a result to dst_addr +

ld_zero_cnt after NOMF instruction.

| | |
|---|---|
| 5) DNOM | DNOM1/DNOM2 |
| DNOM1 | initialize normalizer internal states for |

denormalization. One result is generated.

| | |
|---|---|
| DNOM2 | Denormalization shifting and merging. Result |

generated.

| | |
|---|---|
| 6) ADD | ADD0/ADDC/ADD0L/ADDCL/ADD1L |
| ADD0 | R [symbol] A + B (short pipeline path) |
| ADDC | R [symbol] A + B + c (internal carry) (short |

pipeline path)

| | |
|---|---|
| ADD0L | R [symbol] A + B (long pipeline path) |
| ADDCL | R [symbol] A + B + c (internal carry) (long pipeline |
| path) | |
| ADD1L | R [symbol] ALU_C[260:0] + ALU_S[260:0] + c (internal |
| carry) | |
| 7) SUB | SUB0/SUBC/SUB0L/SUBCL |
| SUB0 | R [symbol] A − B = A + ˜B + 1 (short pipeline |
| path) | |
| SUBC | R [symbol] A + ˜B + c (internal carry) (short |

pipeline path)

| | |
|---|---|
| SUB0L | R [symbol] A − B = A + ˜B + 1 (long pipeline |
| path) | |
| SUBCL | R [symbol] A + ˜B + c (internal carry) (long pipeline |
| path) | |
| 8) MUL | MUL0/MUL1/MUL2 |
| MUL0 | (CSA_C, CSA_S) [symbol] A * B |
| | (ALU_C, ALU_S) [symbol] (CSA_C, CSA_S) >> 256 |
| | R [symbol] CSA_C[255:0] + CSA_S[255:0] |
| MUL1 | (CSA_C, CSA_S) [symbol] A * B |
| | (ALU_C, ALU_S) [symbol] (CSA_C, CSA_S) >> 256 |
| | R [symbol] CSA_C[260:0] + CSA_S[260:0] |
| 9) MAC | MAC0/MAC1/MAC2/MAC3/MAC4 |
| MAC0 | (CSA_C, CSA_S) [symbol] (CSA_C, CSA_S) >> 256 + A * B |
| | (ALU_C, ALU_S) [symbol] (CSA_C, CSA_S) >> 256 |
| | R [symbol] CSA_C[255:0] + CSA_S[255:0] + c (internal |
| carry) | |
| MAC1 | (CSA_C, CSA_S) [symbol] (CSA_C, CSA_S) + A * B |
| | (ALU_C, ALU_S) [symbol] (CSA_C, CSA_S) >> 256 |
| | R [symbol] CSA_C[255:0] + CSA_S[255:0] + c (internal |
| carry) | |

MAC2: (CSA_C, CSA_S) [symbol] (CSA_C, CSA_S) >> 256 + 2 * A * B

| | |
|---|---|
| | (ALU_C, ALU_S) [symbol] (CSA_C, CSA_S) >> 256 |
| | R [symbol] CSA_C[255:0] + CSA_S[255:0] + c (internal |
| carry) | |
| MAC3 | (CSA_C, CSA_S) [symbol] (CSA_C, CSA_S) + 2 * A * B |
| | (ALU_C, ALU_S) [symbol] (CSA_C, CSA_S) >> 256 |
| | R [symbol] CSA_C[255:0] + CSA_S[255:0] + c (internal |
| carry) | |
| MAC4 | (CSA_C, CSA_S) [symbol] (CSA_C, CSA_S) >> 256 + A * B |
| | (ALU_C, ALU_S) [symbol] (CSA_C, CSA_S) >> 256 |
| | R [symbol] CSA_C[260:0] + CSA_S[260:0] + c (internal |
| carry) | |
| MAC8 | (CSA_C, CSA_S) [symbol] (CSA_C, CSA_S) >> 256 + A * B |
| | (ALU_C, ALU_S) [symbol] (CSA_C, CSA_S) >> 256 |
| | No add |
| MAC9 | (CSA_C, CSA_S) [symbol] (CSA_C, CSA_S) + A * B |
| | (ALU_C, ALU_S) [symbol] (CSA_C, CSA_S) >> 256 |
| | No add |
| MAC10 | (CSA_C, CSA_S) [symbol] (CSA_C, CSA_S) >> 256 + |
| | 2 * A * B |
| | (ALU_C, ALU_S) [symbol] (CSA_C, CSA_S) >> 256 |
| | No add |
| MAC11 | (CSA_C, CSA_S) [symbol] (CSA_C, CSA_S) + 2 * A * B |
| | (ALU_C, ALU_S) [symbol] (CSA_C, CSA_S) >> 256 |
| | No add |

The above microcode instructions are generated on the fly and immediately executed by the PKE core to perform the desired operation. The microcode instruction architecture is designed for efficient generic long integer arithmetic operations.

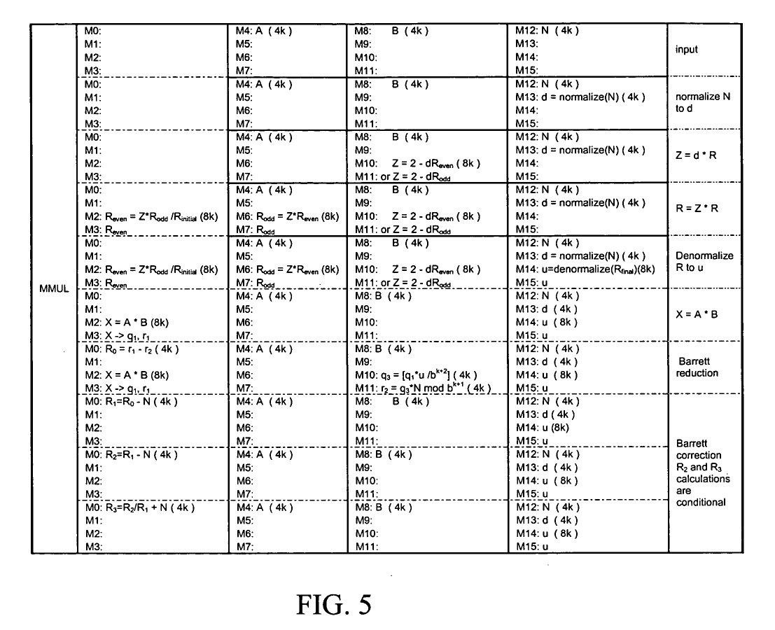

FIG. 5 is an exemplary block diagram depicting the memory structure for a modular multiplication operation of R=A*B mod M (b=2²⁵⁶, k=2), according to one embodiment of the present invention. As shown, the dual port memory 40 is divided into four banks. For example, the first bank 41 is configured for the result of an operation, the second bank 42 is configured for a first operand, the third bank 43 for a second operand and the fourth bank 44 for a third operand. Memory locations are pre-allocated for all input, output, and intermediate results to avoid memory contention.

Stage 0 is a memory snapshot after input. Stage 1 is to normalize modulus N to d which is assigned to location M13. Stage 2 is to compute Z=d*R. New memory locations M9 to M11 are allocated for Z, locations M2 to M3 are allocated for R (for 0^{th}, 2^{nd}, 4^{th}, . . . iterations) and locations M6 to M7 are allocated for R (for 1^{st}, 3^{rd}, 5^{th}, . . . iterations). Stage 3 is to compute R=Z*R. We can see from this stage how M6 to M7 and M2 to M3 are interleavely used for storing R. Stage 2 and Stage 3 are looped until R satisfies the precision requirement. Stage 4 is to shift R to obtain final reciprocal U which is assigned to location M14 to M15. Stage 5 is to compute product of A and B (X=A*B). The product X is allocated at locations M2 to M3 (overwrite R in stage 2 & 3). Stage 6 is to perform partial Barrett Reduction. New locations are allocated for q3 and r2. q1 and r1 each is actually portion of X. Locations M0 is allocated for intermediate result R. Stage 7 to Stage 9 are to perform Barrett correction (R=R−N while R>N). Final result is at location M0. For modular multiplications, two memory reads (portion of A and B) and one write (portion of R) is needed at the same time. However, for modular exponentiation, at the same time that two operands (A and B) are read from memory, additional memory read may be needed for exponent (E), if the current exponent window scanning comes to the end. The memory structure design efficiently use standard dual port (one read one write) memory to build a larger memory that supports three reads and one write.

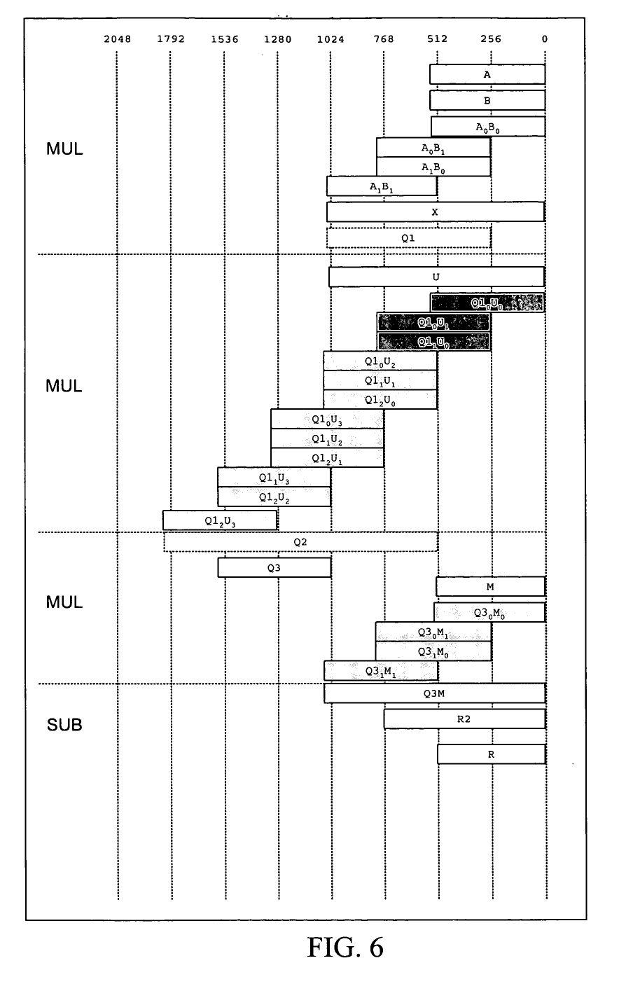

FIG. 6 is an exemplary process flow for a modular multiplication operation of R=A*B mod M (b=2²⁵⁶, k=2).

Stage 1 (MUL): Shows how a 512 bit multiplication A*B (Stage 5 of FIG. 5) is divided into 4 smaller 256 bit multiplications that can be performed in our hardware execution unit. Stage 2 to Stage 4 show how a Barrett reduction (Stage 6 of FIG. 5) is done and optimized. In this example, U=└b^{2k+1}/M┘ is precomputed from Stage 1 to Stage 4 of FIG. 5

Stage 2 (MUL): Computations done in this stage are Q₁=└X/b^{k-1}┘ (part of X, no shifting needed), Q₂=Q₁*U, Q₃=└Q₂/b^{k+2}┘ (part of Q2, no shifting needed). The main operation is a 768 bit*1024 bit multiplication (Q1*U) which is divided into 12 smaller 256 bit multiplication. The first 3 multiplications are drop and not computed at all due to Q2 shifting.

Stage 3 (MUL): Shows how 512 bit multiplication (Q3*M) is broken into 4 256 bit multiplications.

Stage 4 (SUB): Computation done in this stage is R=R₁−R₂ where R₁=X mod b^{k+1} (part of X) and R₂=Q₃*M mod b^{k+1} (part of product Q3M). Note, the final Barrett correction stage is not shown in FIG. 6.

One exemplary memory mapping for the microcode instruction set described above is depcted in Appendix A. The mapping is devised in such a way to eliminate memory contention and maximize pipeline stage usage. In one embodiment, memory space M is 4K bits wide and memory space R is 2K bits wide.

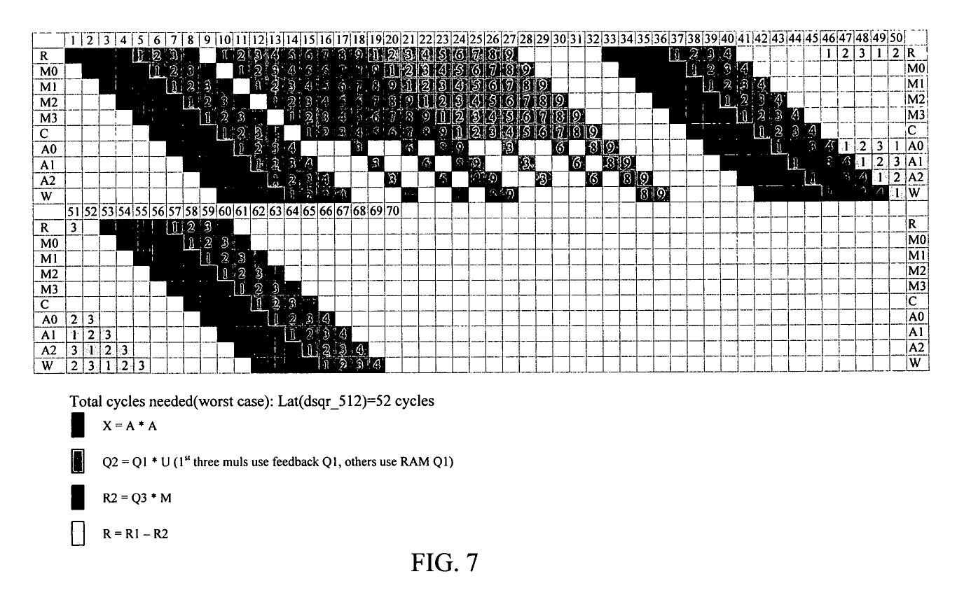

FIG. 7 shows different pipeline stages in an exemplary PKE core for the following exemplary RSA CRT operation:

R (Read) →M0 (Mul0) →M1 (Mul1) →M2 (Mul2) →
M3 (Mul3) →C (CSA) →A0 (Add0)
→A1 (Add1) →A2 (Add2) →W (Write)

As shown, it take 52 cycles for one iteration of two symmetric exponentiation operations. Above pipelines only show one iteration (loop body) with squaring computations. These are the main microcodes for RSA CRT methods. Its formula is:
R₀=R₀*R₀ mod′ P; R₁=R₁*R₁ mod′ Q

Note: “mod′” means only partial Barrett modular reduction is applied. Different drawing patterns are used for different operations within same modulus based operations, similar drawing pattern is used to distinguish two symmetric operations (i.e., P based and Q based). Top line denotes cycle number. From left to right, each entry is one microcode at that cycle. From top to down, the sequencing of the microcode through different pipeline stages is depicted.

Microcode sequence (some of details are omitted for clarity):

| 1 | MUL0 | X₀[0]R₀[0]R₀[0] | | | |
|---|---|---|---|---|---|
| 2 | MAC2 | X₀[1]R₀[0]R₀[1] | | | |
| 3 | MAC0 | X₀[2]R₀[1]R₀[1] | | | |
| 4 | ADD1 | X₀[3] | | | |
| 5 | MUL0 | X₁[0]R₁[0]R₁[0] | | | |
| 6 | MAC2 | X₁[1]R₁[0]R₁[1] | | | |
| 7 | MAC0 | X₁[2]R₁[1]R₁[1] | | | |
| 8 | ADD1 | X₁[3] | | | |
| 9 | NOP | | | | |
| 10 | MUL0 | Q3₀[−2] | Q1₀[0] | Uₚ[2] | (Q3₀[−2] = Q2₀[0]) |
| 11 | MAC9 | Q3₀[−2] | Q1₀[1] | Uₚ[1] | (Q3₀[−2] = Q2₀[0]) |
| 12 | MAC1 | Q3₀[−2] | Q1₀[2] | Uₚ[0] | (Q3₀[−2] = Q2₀[0]) |
| 13 | MAC8 | Q3₀[−1] | Q1₀[0] | Uₚ[3] | (Q3₀[−1] = Q2₀[1]) |
| 14 | MAC9 | Q3₀[−1] | Q1₀[1] | Uₚ[2] | (Q3₀[−1] = Q2₀[1]) |
| 15 | MAC1 | Q3₀[−1] | Q1₀[2] | Uₚ[1] | (Q3₀[−1] = Q2₀[1]) |
| 16 | MAC8 | Q3₀[0] | Q1₀[1] | Uₚ[3] | (Q3₀[0] = Q2₀[2]) |
| 17 | MAC1 | Q3₀[0] | Q1₀[2] | Uₚ[2] | (Q3₀[0] = Q2₀[2]) |
| 18 | MAC4 | Q3₀[1] | Q1₀[2] | Uₚ[3] | (Q3₀[1] = Q2₀[3]) |
| 19 | MUL0 | Q3₁[−2] | Q1₁[0] | U_{q}[2] | (Q3₁[−2] = Q2₁[0]) |
| 20 | MAC9 | Q3₁[−2] | Q1₁[1] | U_{q}[1] | (Q3₁[−2] = Q2₁[0]) |
| 21 | MAC1 | Q3₁[−2] | Q1₁[2] | U_{q}[0] | (Q3₁[−2] = Q2₁[0]) |
| 22 | MAC8 | Q3₁[−1] | Q1₁[0] | U_{q}[3] | (Q3₁[−1] = Q2₁[1]) |
| 23 | MAC9 | Q3₁[−1] | Q1₁[1] | U_{q}[2] | (Q3₁[−1] = Q2₁[1]) |
| 24 | MAC1 | Q3₁[−1] | Q1₁[2] | U_{q}[1] | (Q3₁[−1] = Q2₁[1]) |
| 25 | MAC8 | Q3₁[0] | Q1₁[1] | U_{q}[3] | (Q3₁[0] = Q2₁[2]) |
| 26 | MAC1 | Q3₁[0] | Q1₁[2] | U_{q}[2] | (Q3₁[0] = Q2₁[2]) |
| 27 | MAC4 | Q3₁[1] | Q1₁[2] | U_{q}[3] | (Q3₁[1] = Q2₁[3]) |
| 28-32 | NOP | | | | |
| 33 | MUL0 | R2₀[0] | Q3₀[0] | P[0] | |
| 34 | MAC8 | R2₀[1] | Q3₀[0] | P[1] | |
| 35 | MAC1 | R2₀[1] | Q3₀[1] | P[0] | |
| 36 | MAC0 | R2₀[2] | Q3₀[1] | P[1] | |
| 37 | MUL0 | R2₁[0] | Q3₁[0] | Q[0] | |
| 38 | MAC8 | R2₁[1] | Q3₁[0] | Q[1] | |
| 39 | MAC1 | R2₁[1] | Q3₁[1] | Q[0] | |
| 40 | MAC0 | R2₁[2] | Q3₁[1] | Q[1] | |
| 41-45 | NOP | | | | |
| 46 | SUB0 | R₀[0] | R1₀[0] | R2₀[0] | |
| 47 | SUBC | R₀[1] | R1₀[1] | R2₀[1] | (write to R₀[1] |
| [255:0]) | | | | | |
| 48 | SUBC | R₀[1] | R1₀[2] | R2₀[2] | (write to R₀[1] |

[260:256])

| | | | | | |
|---|---|---|---|---|---|
| 49 | SUB0 | R₁[0] | R1₁[0] | R2₁[0] | |
| 50 | SUBC | R₁[1] | R1₁[1] | R2₁[1] | (write to R₁[1] |

[255:0])

| | | | | | |
|---|---|---|---|---|---|
| 51 | SUBC | R₁[1] | R1₁[2] | R2₁[2] | (write to R₁[1] |

[260:256])

As shown above and in FIG. 7, the pipeline is optimized so that as many operations as possible can be overlapped.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for accelerating a public key operation, the method comprising the steps of:
receiving an input including type of encryption, public key or private key parameters, and data payload;
decoding the received input to determine the type of encryption, the size of the key parameters, and the data payload;
storing the key parameters and the data payload in pre-assigned locations of a memory depending on the determined type of encryption;
generating microcode on the fly responsive to the determined type of encryption and the stored key parameters and the data payload;
executing the generated microcode in a sinle-cycle based pipeline structure; and
outputting the public key operation results.

2. The method of claim 1, wherein the public key operation results are generated for a Rivest Shamir and Adleman (RSA) encryption operation.

3. The method of claim 1, wherein the public key operation results are generated for a DSA sign or verify operation.

4. The method of claim 1, wherein the public key operation results are generated for a Diffie-Hellman (DH) encryption operation.

5. The method of claim 1, wherein the generated microcode does not include any condition checking.

6. The method of claim 1, wherein the generated microcode
performs a multiplication;
performs a partial Barrett reduction; and
performs a final correction, simultaneously.

7. The method of claim 1, wherein the generated microcode performs a modified Barrett method for modular arithmetic and a modified Newton Raphson method for a reciprocal operation.

8. The method of claim 7; wherein the modified Newton Raphson method for a reciprocal operation utilizes one's (1's) complements.

9. A system for accelerating a public key operation comprising:
an input buffer for receiving an input including type of encryption, public key or private key parameters, and data payload;
a parser for decoding the received input to determine the type of encryption, the size of the key parameters, and the data payload;
a memory for storing the key parameters and the data payload in pre-assigned locations depending on the determined type of encryption;
a microcode generation module for generating microcode on the fly responsive to the determined type of encryption and the stored key parameters and the data payload;
an execution unit for executing the generated microcode in a single-cycle based pipeline structure; and
an output buffer for outputting the public key operation results.

10. The system of claim 9, wherein the public key operation results are generated for a Rivest Shamir and Adleman (RSA) encryption operation.

11. The system of claim 9, wherein the public key operation results are generated for a DSA sign or verify operation.

12. The system of claim 9, wherein the public key operation results are generated for a Diffie-Hellman (DH) encryption operation.

13. The system of claim 9, wherein the generated microcode does not include any condition checking.

14. The system of claim 9, wherein the execution unit executes the generated microcode for performing a multiplication, a partial Barrett reduction, and a final correction, simultaneously.

15. The system of claim 9, wherein the memory is a dual-port random acceess memory (RAM) and is capable of supporting three read operations and one write operation simultaneously.

16. The system of claim 9, wherein the execution unit includes a reciprocal module, an exponential module, a multiplier/adder (MAC) module, and shifting logic.

17. The system of claim 9, further comprising a microcode decoder for decoding the generated microcode for execution.

18. The system of claim 9, wherein the generated microcode performs a modified Barrett method for modular arithmetic and a modified Newton Raphson method for a reciprocal operation.

19. The system of claim 18, wherein the modified Newton Raphson method for a reciprocal operation utilizes one's (1's) complements.

20. A system for accelerating a public key operation comprising:
means for receiving an input including type of encryption, size of public key or private key parameters, and data payload;
means for decoding the received input to determine the type of encryption, the size of the key parameters, and the data payload;
means for storing the key parameters and the data payload in pre-assigned locations depending on the determined type of encryption;
means for generating microcode on the fly responsive to the determined type of encryption and the stored key parameters and the data payload;
means for executing the generated microcode in a single-cycle based pipeline structure; and
means for outputting the public key operation results.
